(19) United States
(12) Patent Application Publication
(10) Pub. No.: US 2025/0021194 A1
(43) Pub. Date: Jan. 16, 2025

(54) ON-CELL TOUCH AND FORCE SENSING IN DISPLAY

(71) Applicant: Apple Inc., Cupertino, CA (US)

(72) Inventors: Wenqing DAI, San Jose, CA (US); Isaac W. CHAN, San Jose, CA (US); Chun Hao TUNG, San Jose, CA (US); Nikhil DOLE, Castro Valley, CA (US); Vyom SHARMA, Newark, CA (US); Szhsiao CHEN, Osaka (JP); Sunggu KANG, San Jose, CA (US)

(21) Appl. No.: 18/770,305

(22) Filed: Jul. 11, 2024

Related U.S. Application Data
(60) Provisional application No. 63/513,338, filed on Jul. 12, 2023.

(51) Int. Cl. G06F 3/044; G06F 3/041

(52) U.S. Cl. CPC G06F 3/044; G06F 3/0416; G06F 2203/04105; G06F 2203/04107

(57) ABSTRACT

In some examples, a touch and force sensitive device includes integrated circuitry configured to attenuate noise in a first period of operation, and sense force of an object contacting the device in a second period of operation. In some examples, a touch and force sensitive device includes integrated circuitry formed from a same material layer, the material layer configured to detect a force of an object contacting the device in first one or more regions of the material layer, and configured to couple touch detection circuitry in second one or more regions of the material layer.

### CROSS-REFERENCE TO RELATED APPLICATIONS

This application claims the benefit of U.S. Provisional Application No. 63/513,338, filed Jul. 12, 2023, the entire disclosure of which is herein incorporated by reference for all purposes.

### FIELD OF THE DISCLOSURE

This relates generally to touch sensor panels/screens, and more particularly to touch sensor panels/screens with integrated force sensing circuitry.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular, are popular because of their ease and versatility of operation as well as their declining price. Touch screens can include a touch sensor panel, which can be a clear panel with a touch-sensitive surface, and a display device such as a liquid crystal display (LCD), light emitting diode (LED) display or organic light emitting diode (OLED) display that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electrical fields used to detect touch can extend beyond the surface of the display, and objects approaching near the surface may be detected near the surface without actually touching the surface.

Capacitive touch sensor panels can be formed by a matrix of partially or fully transparent or non-transparent conductive plates (e.g., touch electrodes) made of materials such as Indium Tin Oxide (ITO). In some examples, the conductive plates can be formed from other materials including conductive polymers, metal mesh, graphene, nanowires (e.g., silver nanowires) or nanotubes (e.g., carbon nanotubes). It is due in part to their substantial transparency that some capacitive touch sensor panels can be overlaid on a display to form a touch screen, as described above. Some touch screens can be formed by at least partially integrating touch sensing circuitry into a display pixel stack-up (i.e., the stacked material layers forming the display pixels). Some touch screens can include circuitry to detect a force of a touch on the touch screen.

### SUMMARY OF THE DISCLOSURE

This relates to touch sensor panels (or touch screens or touch-sensitive surfaces) with integrated force sensing circuitry (e.g., force sensing electrodes and/or associated circuitry for stimulating, measuring, or switching to enable force sensing operations described herein). In some examples, a touch screen stack-up includes one or more layers of materials configured to act as a shield to mitigate noise coupling between display circuitry and touch detection circuitry during a first mode of operation, and configured to act as force sensing circuitry during a second mode of operation. In some examples, a touch screen includes a force and shielding layer (e.g., implementing force and shielding functionality in a single layer). In some examples, the force and shielding layer includes one or more conductive materials, such as one or more silver nanowires. In some examples, the force and shielding layer can be configured to detect a force of a contact (or forces of multiple contacts) with a touch screen, and further configured to prevent noise coupling between the display components and touch metal layers during different modes of operation of the touch screen.

In some examples, during a first mode of operation, the force and shielding layer is connected to a shield voltage. The shield voltage optionally corresponds to an electrical ground, and/or another voltage configured to attenuate any signals coupling between display circuitry and touch detection circuitry. In some examples, during a second, different mode of operation, the force and shielding layer is configured to couple one or more stimulation sources, to one or more strain gauges included in the shield and force sensing layer. In some examples, in response to detecting a change in resistance of the one or more strain gauges, the touch screen determines a force of a contact applied to the touch screen.

In some examples, the conductive material disposed in the force and shielding layer is patterned to optimize the shielding capabilities and/or the force sensing capabilities. In some examples, the force and shield layer can include electrodes including a plurality of silver nanowires. In some examples, the force and shield layer includes a plurality of serpentine-patterned strain gauges. In some examples, the force and shielding layer is separate from one or more touch detection layers (e.g., by a dielectric layer). In some examples, the force and shielding layer is at least partially transparent, or nearly transparent (e.g., light from the display is visible through the force and shielding layer without degrading the visual expectations of a human viewer of the display).

In some examples, the touch screen includes one or more strain gauges. In some examples, the touch screen includes force sensing circuitry, including force stimulation circuitry, couplable to excite and measure the one or more strain gauges. In some examples, the one or more strain gauges are implemented using a Wheatstone bridge configuration. In some examples, the Wheatstone bridge is configured in a balanced or unbalanced arrangement.

In some examples, in a first mode of operation, the touch screen uses force sensing circuitry, including switching circuitry, to configure the one or more strain gauges in a shielded configuration. In some examples, the shielded configuration includes coupling (e.g., using the switching circuitry) the one or more strain gauges to an electrical ground. In some examples, the shielded configuration includes coupling (e.g., using the switching circuitry) the one or more strain gauges to shield stimulation source. In some examples, while in the first mode of operation, the touch screen decouples (e.g., using the switching circuitry) force stimulation and/or sensing circuitry otherwise configured to excite and/or measure strain (e.g., by measuring an output voltage) and/or various impedances of the Wheatstone bridge. In some examples, in a second mode of operation, the touch screen uses the switching circuitry to couple one or more stimulus sources to the one or more strain gauges, and to couple force sensing circuitry to measure a change in the output voltage or impedances of the Wheatstone bridge. In some examples, in the second mode of operation, the touch screen decouples (e.g., using the switching circuitry) the one or more strain gauges from one or more shield sources.

In some examples, the touch screen includes force sensing circuitry and/or force controller. In some examples, the touch screen includes circuitry to convert measurements of current and/or voltage of the one or more strain gauges to digital information, such as one or more analog-to-digital converters.

In some examples, a touch screen stack-up includes a substrate, display components (e.g., including light emitting diodes and/or display driving circuitry), touch components (e.g., including touch electrodes and touch detection circuitry), and the force and shield components (e.g., force and/or shield electrodes, force detection circuitry, and/or shield driving circuitry). In some examples, the display components, touch components, and the force and shield components are implemented in an on-cell architecture in which electrodes used for touch and force detection (and/or shielding) are fabricated as part of the display fabrication process (e.g., instead of using adhesive to attach a fabricated touch and/or force sensor panel to a fabricated display). In some examples, the touch screen includes one or more encapsulation layers. In some examples, the shield layer can be flooded with conductive material(s). In some examples, the shield layer can include a global metal mesh pattern. In some examples, the shield layer can include a combination of the metal mesh flooded with a conductive material. In some examples, patches of the flood of conductive material can be disposed between the metal mesh. In some examples, the shield layer comprises one or more conductive materials such as metal or semiconductor materials. In some examples, the dimension of the metal mesh is based on dimensions of display components included in the touch screen.

In some examples, the touch screen includes a touch layer and an interconnect and force detecting layer. In some examples, the interconnect and force detecting layer comprises a first metal layer, separate from a second metal layer corresponding to the touch layer that is configured for detecting a location of touch. In some examples, the first and the second metal layers comprise different respective conductive materials. In some examples, the first metal layer includes a plurality of strain gauges. In some examples, the plurality of strain gauges is configured to detect a force of an object contacting the touch screen. In some examples, the interconnect and force detecting layer includes a portion of the metal material electrically coupling touch electrodes formed from the second metal layer.

### BRIEF DESCRIPTION OF THE DRAWINGS

FIGS. 1A-1E illustrate example systems that can include a touch screen according to examples of the disclosure.

FIG. 2 illustrates an example computing system including a touch screen according to examples of the disclosure.

FIG. 3A illustrates an exemplary touch sensor circuit corresponding to a self-capacitance measurement of a touch node electrode and sensing circuit according to examples of the disclosure.

FIG. 3B illustrates an exemplary touch sensor circuit corresponding to a mutual-capacitance drive line and sense line and sensing circuit according to examples of the disclosure.

FIG. 4A illustrates touch screen with touch electrodes arranged in rows and columns according to examples of the disclosure.

FIG. 4B illustrates touch screen with touch node electrodes arranged in a pixelated touch node electrode configuration according to examples of the disclosure.

FIG. 5A illustrates an example touch screen stack-up including a metal mesh layer according to examples of the disclosure.

FIG. 5B illustrates an example touch screen stack-up including a shield and force detecting device according to examples of the disclosure.

FIG. 5C illustrates an example serpentine pattern for shield and force detection according to examples of the disclosure.

FIG. 5D illustrates an example of shield and force detecting circuitry according to examples of the disclosure.

FIG. 6 illustrates an example interconnect and force detecting device according to examples of the disclosure.

FIG. 7 illustrates an example method for configuring a touch screen stack-up to detect force and/or to perform shielding according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to touch sensor panels (or touch screens or touch-sensitive surfaces) with force detecting circuitry. In some examples, a touch screen stack-up includes one or more layers of materials configured to act as a shield to mitigate noise coupling between display circuitry and touch detection circuitry during a first mode of operation, and configured to act as force sensing circuitry during a second mode of operation. In some examples, a touch screen includes a force and shielding layer. In some examples, the force and shielding layer includes one or more materials, such as one or more silver nanowires. In some examples, the force and shielding layer can configured to detect forces of contacts with a touch screen and further configured to prevent noise coupling between the display components and touch metal layers during different modes of operation of the touch screen.

In some examples, during a first mode of operation, the force and shielding layer is connected to a shield voltage. The shield voltage optionally corresponds to an electrical ground, and/or another voltage configured to attenuate any signals coupling between display circuitry and touch detection circuitry. In some examples, during a second, different mode of operation, the force and shielding layer is configured to couple one or more stimulation sources, to one or more strain gauges included in the shield and force sensing layer. In some examples, in response to detecting a change in resistance of the one or more strain gauges, the touch screen determines a force of a contact applied to the touch screen.

In some examples, the force and shielding layer is patterned and/or disposed to optimize the shielding capabilities and/or the force sensing capabilities. In some examples, the force and shield layer includes a plurality of serpentine-patterned conductive segments, such as strain gauges. In some examples, the force and shielding layer is separate from one or more touch detection layers. In some examples, the force and shielding layer is at least partially transparent, or nearly transparent.

In some examples, the touch screen includes one or more strain gauges. In some examples, the touch screen includes force sensing circuitry, including force stimulation circuitry, coupled to excite and measure the one or more strain gauges. In some examples, the one or more strain gauges are arranged in a Wheatstone bridge configuration. In some examples, the Wheatstone bridge is configured in a balanced or unbalanced arrangement.

In some examples, in a first mode of operation, the touch screen uses force sensing circuitry to arrange the one or more strain gauges in a shielded configuration. In some examples, the shielded configuration includes coupling the one or more strain gauges to an electrical ground. In some examples, the shielded configuration includes coupling the one or more strain gauges to shield stimulation source. In some examples, while in the first mode of operation, the touch screen decouples force stimulation circuitry otherwise configured to measure impedances of the Wheatstone bridge. In some examples, in a second mode of operation, the touch screen uses the force switching circuitry to couple stimulus source(s) to the one or more strain gauges, and to couple force sensing circuitry to measure a change in the impedances of the Wheatstone bridge. In some examples, in the second mode of operation, the touch screen decouples the one or more strain gauges from one or more shield sources.

In some examples, the touch screen includes force sensing circuitry and/or force controller. In some examples, the touch screen includes circuitry to convert measurements of current and/or voltage of the one or more strain gauges to digital information, such as via one or more analog-to-digital converters.

In some examples, a touch screen can be built on a substrate, including display components, touch detection circuitry, and the force and shield circuitry. In some examples, the display components, touch detection circuitry, and the force and shield circuitry are manufactured on-cell. In some examples, the touch screen includes one or more encapsulation layers. In some examples, the shield layer can be flooded with conductive material(s). In some examples, the shield layer can include with a global mesh pattern. In some examples, the shield layer can include a combination of the metal mesh flooded with a conductive material. In some examples, patches of the flood of conductive material can be disposed between the metal mesh. In some examples, the shield layer comprises one or more materials such as metal materials. In some examples, the force and shield layer is configured in a metal mesh. In some examples, the dimension of the metal mesh is based on dimensions of display components included in the touch screen. In some examples, the touch screen includes a cover layer. In some examples, the touch screen includes an adhesive layer. In some examples, the touch screen includes a dielectric layer.

In some examples, the touch screen includes an interconnect and force detecting layer. In some examples, the interconnect and force detecting layer comprises a first metal layer, separate from a second metal layer that is configured to detect a location of touch. In some examples, the first and the second metal layers comprise different respective materials. In some examples, the first metal layer includes a plurality of strain gauges. In some examples, the plurality of strain gauges is configured to detect a force of an object contacting the touch screen. In some examples, the interconnect and force detecting layer includes a portion of the metal material electrically coupling touch electrodes formed from the second metal layer.

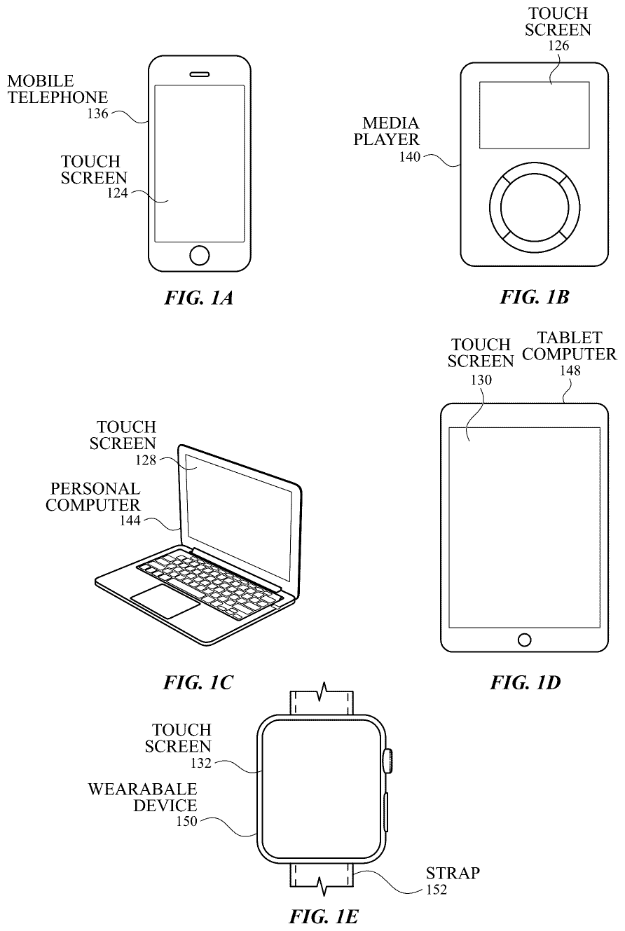

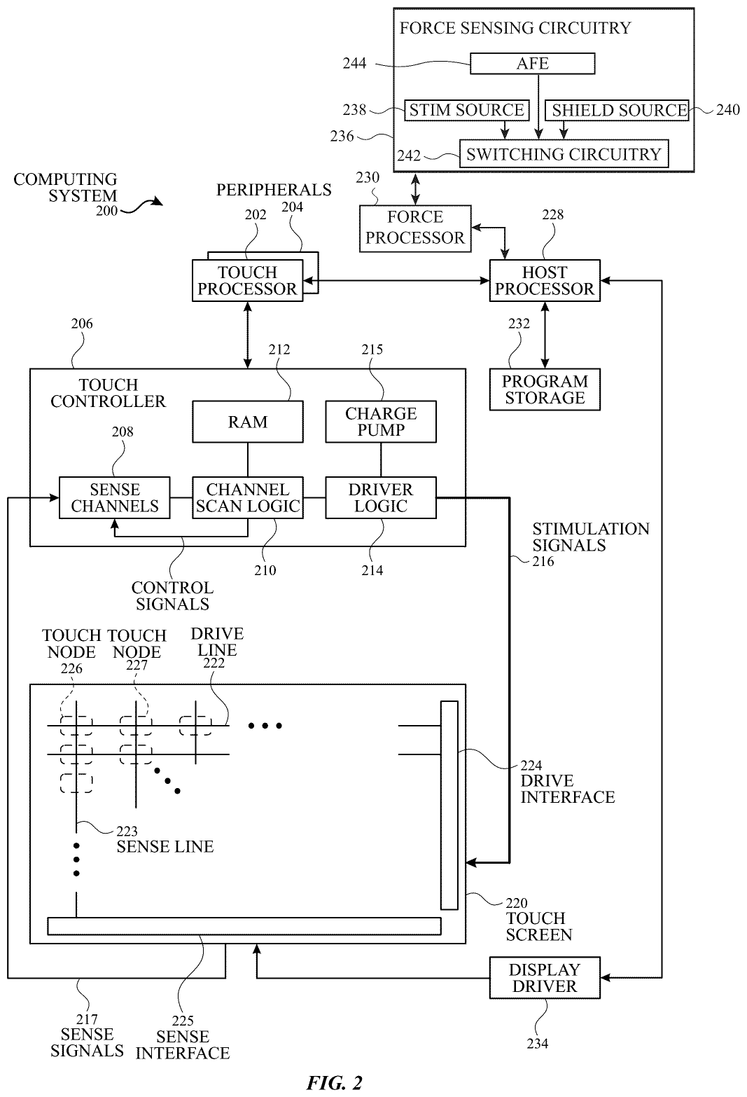

FIGS. 1A-1E illustrate example systems that can include a touch screen according to examples of the disclosure. As described herein, the touch screen can include integrated force sensing circuitry and/or a shield. FIG. 1A illustrates an example mobile telephone 136 that includes a touch screen 124 according to examples of the disclosure. FIG. 1B illustrates an example digital media player 140 that includes a touch screen 126 according to examples of the disclosure. FIG. 1C illustrates an example personal computer 144 that includes a touch screen 128 according to examples of the disclosure. FIG. 1D illustrates an example tablet computing device 148 that includes a touch screen 130 according to examples of the disclosure. FIG. 1E illustrates an example wearable device 150 that includes a touch screen 132 and can be attached to a user using a strap 152 according to examples of the disclosure. It is understood that a touch screen can be implemented in other devices as well.

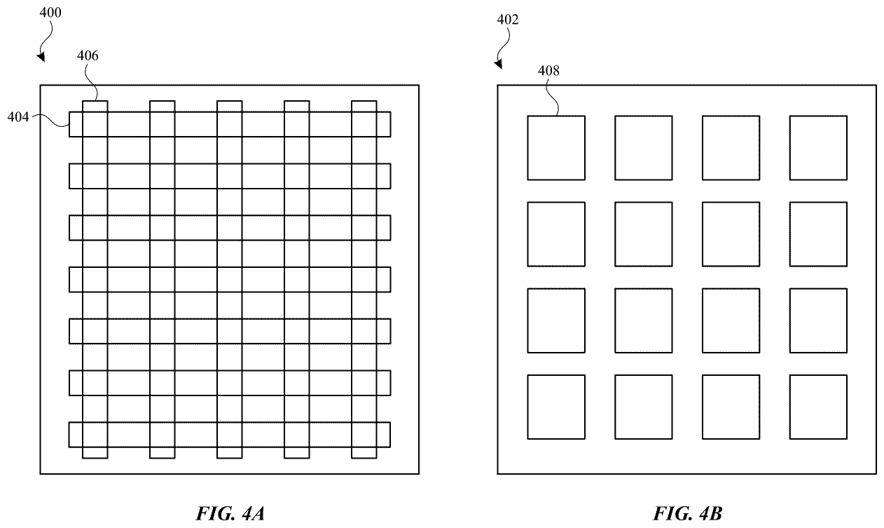

In some examples, touch screens 124, 126, 128, 130 and 132 can be based on self-capacitance. A self-capacitance based touch system can include a matrix of small, individual plates of conductive material or groups of individual plates of conductive material forming larger conductive regions that can be referred to as touch electrodes or as touch node electrodes (as described below with reference to FIG. 4B). For example, a touch screen can include a plurality of individual touch electrodes, each touch electrode identifying or representing a unique location (e.g., a touch node) on the touch screen at which touch or proximity is to be sensed, and each touch node electrode being electrically isolated from the other touch node electrodes in the touch screen/panel. Such a touch screen can be referred to as a pixelated self-capacitance touch screen, though it is understood that in some examples, the touch node electrodes on the touch screen can be used to perform scans other than self-capacitance scans on the touch screen (e.g., mutual capacitance scans). During operation, a touch node electrode can be stimulated with an alternating current (AC) waveform, and the self-capacitance to ground of the touch node electrode can be measured. As an object approaches the touch node electrode, the self-capacitance to ground of the touch node electrode can change (e.g., increase). This change in the self-capacitance of the touch node electrode can be detected and measured by the touch sensing system to determine the positions of multiple objects when they touch, or come in proximity to, the touch screen. In some examples, the touch node electrodes of a self-capacitance based touch system can be formed from rows and columns of conductive material, and changes in the self-capacitance to ground of the rows and columns can be detected, similar to above. In some examples, a touch screen can be multi-touch, single touch, projection scan, full-imaging multi-touch, capacitive touch, etc.

In some examples, touch screens 124, 126, 128, 130 and 132 can be based on mutual capacitance. A mutual capacitance based touch system can include electrodes arranged as drive and sense lines that may cross over each other on different layers (in a double-sided configuration), or may be adjacent to each other on the same layer (e.g., as described below with reference to FIG. 4A). The crossing or adjacent locations can form touch nodes. During operation, the drive line can be stimulated with an AC waveform and the mutual capacitance of the touch node can be measured. As an object approaches the touch node, the mutual capacitance of the touch node can change (e.g., decrease). This change in the mutual capacitance of the touch node can be detected and measured by the touch sensing system to determine the positions of multiple objects when they touch, or come in proximity to, the touch screen. As described herein, in some examples, a mutual capacitance based touch system can form touch nodes from a matrix of small, individual plates of conductive material.

In some examples, touch screens 124, 126, 128, 130 and 132 can be based on mutual capacitance and/or self-capacitance. The electrodes can be arranged as a matrix of small, individual plates of conductive material (e.g., as in touch node electrodes 408 in touch screen 402 in FIG. 4B) or as drive lines and sense lines (e.g., as in row touch electrodes 404 and column touch electrodes 406 in touch screen 400 in FIG. 4A), or in another pattern. The electrodes can be configurable for mutual capacitance or self-capacitance sensing or a combination of mutual and self-capacitance sensing. For example, in one mode of operation electrodes can be configured to sense mutual capacitance between electrodes and in a different mode of operation electrodes can be configured to sense self-capacitance of electrodes. In some examples, some of the electrodes can be configured to sense mutual capacitance therebetween and some of the electrodes can be configured to sense self-capacitance thereof.

FIG. 2 illustrates an example computing system including a touch screen according to examples of the disclosure. Computing system 200 can be included in, for example, a mobile phone, tablet, touchpad, portable or desktop computer, portable media player, wearable device or any mobile or non-mobile computing device that includes a touch screen or touch sensor panel. Computing system 200 can include a touch sensing system including one or more touch processors 202, peripherals 204, a touch controller 206, and touch sensing circuitry (described in more detail below). Peripherals 204 can include, but are not limited to, random access memory (RAM) or other types of memory or storage, watchdog timers and the like. Touch controller 206 can include, but is not limited to, one or more sense channels 208, channel scan logic 210 and driver logic 214. Channel scan logic 210 can access RAM 212, autonomously read data from the sense channels and provide control for the sense channels. In addition, channel scan logic 210 can control driver logic 214 to generate stimulation signals 216 at various frequencies and/or phases that can be selectively applied to drive regions of the touch sensing circuitry of touch screen 220, as described in more detail below. In some examples, touch controller 206, touch processor 202 and peripherals 204 can be integrated into a single application specific integrated circuit (ASIC), and in some examples can be integrated with touch screen 220 itself.

It should be apparent that the architecture shown in FIG. 2 is only one example architecture of computing system 200, and that the system could have more or fewer components than shown, or a different configuration of components. In some examples, computing system 200 can include an energy storage device (e.g., a battery) to provide a power supply and/or communication circuitry to provide for wired or wireless communication (e.g., cellular, Bluetooth, Wi-Fi, etc.). The various components shown in FIG. 2 can be implemented in hardware, software, firmware or any combination thereof, including one or more signal processing and/or application specific integrated circuits.

Computing system 200 can include a host processor 228 for receiving outputs from touch processor 202 and performing actions based on the outputs. For example, host processor 228 can be connected to program storage 232 and a display controller/driver 234 (e.g., a Liquid-Crystal Display (LCD) driver). It is understood that although some examples of the disclosure may be described with reference to LCD displays, the scope of the disclosure is not so limited and can extend to other types of displays, such as Light-Emitting Diode (LED) displays, including Organic LED (OLED), Active-Matrix Organic LED (AMOLED) and Passive-Matrix Organic LED (PMOLED) displays. Display driver 234 can provide voltages on select (e.g., gate) lines to each pixel transistor and can provide data signals along data lines to these same transistors to control the pixel display image.

Host processor 228 can use display driver 234 to generate a display image on touch screen 220, such as a display image of a user interface (UI), and can use touch processor 202 and touch controller 206 to detect a touch on or near touch screen 220, such as a touch input to the displayed UI. The touch input can be used by computer programs stored in program storage 232 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like.

Host processor 228 is also communicatively coupled to force processor 230. Host processor 228 can cause force processor 236 to detect a force of a touch or multiple touches on touch screen 220 and/or receive the detected force from force processor 236. The force corresponding the touch input directed to the displayed UI can be used by the computer programs stored in program storage 232 to perform similar actions as described previously (and/or augment these actions). Host processor 228 can also perform additional functions that may not be related to controlling touch and/or force sensing, and/or processing touch and/or force input.

Note that one or more of the functions described herein, can be performed by firmware stored in memory (e.g., one of the peripherals 204 in FIG. 2) and executed by touch processor 202 and/or force processor 230, or stored in program storage 232 and executed by host processor 228. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. In some examples, RAM 212 or program storage 232 (or both) can be a non-transitory computer readable storage medium. One or both of RAM 212 and program storage 232 can have stored therein instructions, which when executed by touch processor 202, force processor 230, or host processor 228, and/or some combination of such processor(s), can cause the device including computing system 200 to perform one or more functions and methods of one or more examples of this disclosure. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

Touch screen 220 can be used to derive touch information at multiple discrete locations of the touch screen, referred to herein as touch nodes. Touch screen 220 can include touch sensing circuitry that can include a capacitive sensing medium having a plurality of drive lines 222 and a plurality of sense lines 223. It should be noted that the term “lines” is sometimes used herein to mean simply conductive pathways, as one skilled in the art will readily understand, and is not limited to elements that are strictly linear, but includes pathways that change direction, and includes pathways of different sizes, shapes, materials, etc. Drive lines 222 can be driven by stimulation signals 216 from driver logic 214 through a drive interface 224, and resulting sense signals 217 generated in sense lines 223 can be transmitted through a sense interface 225 to sense channels 208 in touch controller 206. In this way, drive lines and sense lines can be part of the touch sensing circuitry that can interact to form capacitive sensing nodes, which can be thought of as touch picture elements (touch pixels) and referred to herein as touch nodes, such as touch nodes 226 and 227. This way of understanding can be particularly useful when touch screen 220 is viewed as capturing an “image” of touch (“touch image”). In other words, after touch controller 206 has determined whether a touch has been detected at each touch nodes in the touch screen, the pattern of touch nodes in the touch screen at which a touch occurred can be thought of as an “image” of touch (e.g., a pattern of fingers touching the touch screen). As used herein, an electrical component “coupled to” or “connected to” another electrical component encompasses a direct or indirect connection providing electrical path for communication or operation between the coupled components. Thus, for example, drive lines 222 may be directly connected to driver logic 214 or indirectly connected to drive logic 214 via drive interface 224 and sense lines 223 may be directly connected to sense channels 208 or indirectly connected to sense channels 208 via sense interface 225. In either case an electrical path for driving and/or sensing the touch nodes can be provided.

Touch screen 220 can be used to derive force information at multiple discrete locations of the touch screen, referred to herein as force nodes. The force nodes optionally correspond to (e.g., match) locations of touch nodes. In some examples, each force node corresponds to a touch node such that the touch and force can be measured at each respective location corresponding to a respective touch node and force node pair. In some examples, there are fewer force nodes than touch nodes such that a given force node can detect force corresponding to a group of touch nodes. Force sensing circuitry 236 optionally includes circuitry to drive (stimulation source 238), measure (e.g., analog front end (AFE) 244), and/or control coupling/decoupling between the AFE 244 (also referred to herein as force detection circuitry) and the one or more strain gauges (e.g., implemented with one or more electrodes, optionally in a Wheatstone bridge configuration) in response to information and/or commands communicated between force processor 230 and force sensing circuitry 236. For example, force sensing circuitry 236 optionally includes one or more stimulation sources 238. The stimulation sources optionally provide one or more voltage waveforms (e.g., sinusoids, DC voltages, and/or modulated waveforms) that can excite the strain gauges sensed by AFE 244. One or more channels of one or more AFEs can be coupled to the one or more strain gauges integrated on-cell into touch screen 220 (described further herein). In some examples, switching circuitry 242 is configured to selectively couple one or more terminals of the one or more strain gauges the one or more stimulation sources 238 and/or ground terminals, thus driving the one or more strain gauges to respective voltage levels, enabling AFE 244 to detect changes in forces applied to touch screen 220. In some examples, during a mode of operation, touch screen 220 uses switching circuitry 242 to couple the electrodes corresponding to one or more strain gauges to one or more shield sources 240. The shield sources 240 optionally correspond to an electrical ground, or another active stimulation source configured to reduce noise coupling into touch circuitry from display circuitry included in touch screen 220. In some examples, components and functionality of force sensing circuitry 236 are implemented separately. For example, the switching functionality of switching circuitry 242 or the stimulation and shield sources may be implemented separately from the AFEs 244.

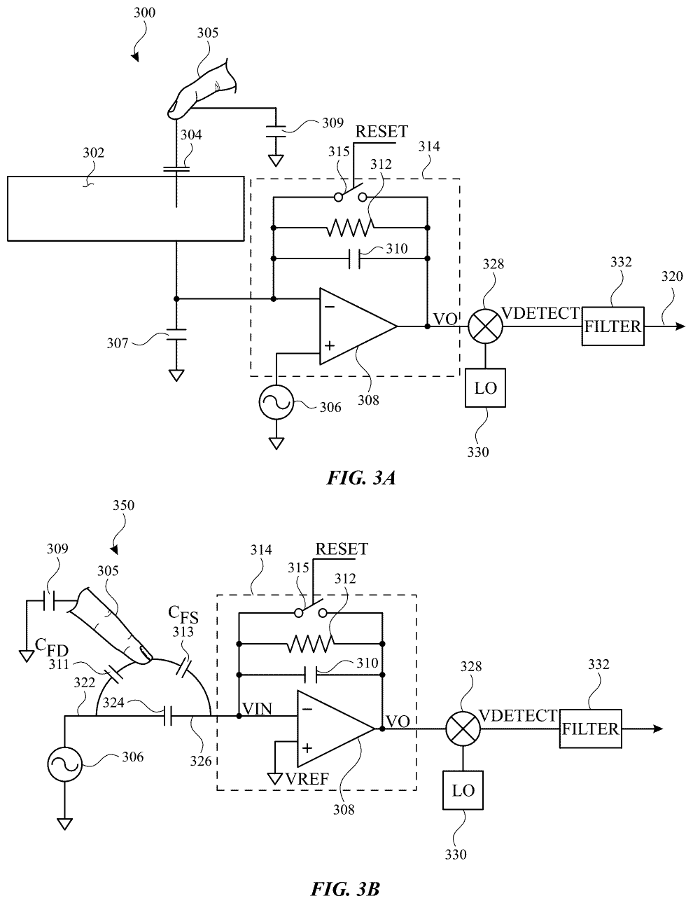

FIG. 3A illustrates an exemplary touch sensor circuit 300 corresponding to a self-capacitance measurement of a touch node electrode 302 and sensing circuit 314 according to examples of the disclosure. Touch node electrode 302 can correspond to a touch electrode 404 or 406 of touch screen 400 or a touch node electrode 408 of touch screen 402. Touch node electrode 302 can have an inherent self-capacitance to ground associated with it, and also an additional self-capacitance to ground that is formed when an object, such as finger 305, is in proximity to or touching the electrode. The total self-capacitance to ground of touch node electrode 302 can be illustrated as capacitance 304. Touch node electrode 302 can be coupled to sensing circuit 314. Sensing circuit 314 can include an operational amplifier 308, feedback resistor 312 and feedback capacitor 310, although other configurations can be employed. For example, feedback resistor 312 can be replaced by a switched capacitor resistor in order to minimize a parasitic capacitance effect that can be caused by a variable feedback resistor. Touch node electrode 302 can be coupled to the inverting input (−) of operational amplifier 308. An AC voltage source (V_{ac}) corresponding to stimulation signal 306 can be coupled to the non-inverting input (+) of operational amplifier 308. Touch sensor circuit 300 can be configured to sense changes (e.g., increases) in the total self-capacitance 304 of the touch node electrode 302 induced by a finger or object either touching or in proximity to the touch sensor panel. Output 320 can be used by a processor to determine the presence of a proximity or touch event, or the output can be inputted into a discrete logic network to determine the presence of a proximity or touch event.

FIG. 3B illustrates an exemplary touch sensor circuit 350 corresponding to a mutual-capacitance drive line 322 and sense line 326 and sensing circuit 314 according to examples of the disclosure. Drive line 322 can be stimulated by stimulation signal 306 (e.g., an AC voltage signal). Stimulation signal 306 can be capacitively coupled to sense line 326 through mutual capacitance 324 between drive line 322 and the sense line. When a finger 305 or object approaches the touch node created by the intersection of drive line 322 and sense line 326, mutual capacitance 324 can change (e.g., decrease) (e.g., due to capacitive coupling indicated by capacitances C_{FD} 311 and C_{FS} 313, which can be formed between drive line 322, finger 305 and sense line 326). This change in mutual capacitance 324 can be detected to indicate a touch or proximity event at the touch node, as described herein. The sense signal coupled onto sense line 326 can be received by sensing circuit 314. Sensing circuit 314 can include operational amplifier 308 and at least one of a feedback resistor 312 and a feedback capacitor 310. FIG. 3B illustrates a general case in which both resistive and capacitive feedback elements are utilized. The sense signal (referred to as Vin) can be inputted into the inverting input of operational amplifier 308, and the non-inverting input of the operational amplifier can be coupled to a reference voltage V_{ref}. Operational amplifier 308 can drive its output to voltage Vₒ to keep Vᵢₙ substantially equal to V_{ref}, and can therefore maintain Vᵢₙ constant or virtually grounded. A person of skill in the art would understand that in this context, equal can include deviations of up to 15%. Therefore, the gain of sensing circuit 314 can be mostly a function of the ratio of mutual capacitance 324 and the feedback impedance, comprised of resistor 312 and/or capacitor 310. The output of sensing circuit 314 Vo can be filtered and heterodyned or homodyned by being fed into multiplier 328, where Vo can be multiplied with local oscillator 330 to produce V_{detect}. V_{detect} can be inputted into filter 332. One skilled in the art will recognize that the placement of filter 332 can be varied; thus, the filter can be placed after multiplier 328, as illustrated, or two filters can be employed: one before the multiplier and one after the multiplier. In some examples, there can be no filter at all. The direct current (DC) portion of V detect can be used to determine if a touch or proximity event has occurred. Note that while FIGS. 3A-3B indicate the demodulation at multiplier 328 occurs in the analog domain, output Vo may be digitized by an analog-to-digital converter (ADC), and operational blocks corresponding to multiplier 328, filter 332 and/or local oscillator 330 may be implemented in a digital fashion (e.g., 328 can be a digital demodulator, 332 can be a digital filter, and 330 can be a digital NCO (Numerical Controlled Oscillator).

Referring back to FIG. 2, in some examples, touch screen 220 can be an integrated touch screen in which touch sensing circuit elements of the touch sensing system can be integrated into the display pixel stack-ups of a display. The circuit elements in touch screen 220 can include, for example, elements that can exist in LCD or other displays (LED display, OLED display, etc.), such as one or more pixel transistors (e.g., thin film transistors (TFTs)), gate lines, data lines, pixel electrodes and common electrodes. In a given display pixel, a voltage between a pixel electrode and a common electrode can control a luminance of the display pixel. The voltage on the pixel electrode can be supplied by a data line through a pixel transistor, which can be controlled by a gate line. It is noted that circuit elements are not limited to whole circuit components, such as a whole capacitor, a whole transistor, etc., but can include portions of circuitry, such as only one of the two plates of a parallel plate capacitor.

FIG. 4A illustrates touch screen 400 with touch electrodes 404 and 406 arranged in rows and columns according to examples of the disclosure. Specifically, touch screen 400 can include a plurality of touch electrodes 404 disposed as rows, and a plurality of touch electrodes 406 disposed as columns. Touch electrodes 404 and touch electrodes 406 can be on the same or different material layers on touch screen 400, and can intersect with each other, as illustrated in FIG. 4A. In some examples, the electrodes can be formed on opposite sides of a transparent (partially or fully) substrate and from a transparent (partially or fully) semiconductor material, such as ITO, though other materials are possible. Electrodes displayed on layers on different sides of the substrate can be referred to herein as a double-sided sensor. In some examples, touch screen 400 can sense the self-capacitance of touch electrodes 404 and 406 to detect touch and/or proximity activity on touch screen 400, and in some examples, touch screen 400 can sense the mutual capacitance between touch electrodes 404 and 406 to detect touch and/or proximity activity on touch screen 400.

Although FIG. 4A illustrates touch electrodes 404 and touch electrodes 406 as rectangular electrodes, in some examples, other shapes and configurations are possible for row and column electrodes. For example, in some examples, some or all row and column electrodes can be formed from multiple touch electrodes formed on one side of substrate from a transparent (partially or fully) semiconductor material. The touch electrodes of a particular row or column can be interconnected by coupling segments and/or bridges. Row and column electrodes formed in a layer on the same side of a substrate can be referred to herein as a single-sided sensor. As described in more detail below, row and column electrodes can have other shapes. Additionally, although primarily described in terms of a row-column configuration, it is understood that in some examples, the same principles can be applied to two-axis array of touch nodes in a non-rectilinear arrangement.

FIG. 4B illustrates touch screen 402 with touch node electrodes 408 arranged in a pixelated touch node electrode configuration according to examples of the disclosure. Specifically, touch screen 402 can include a plurality of individual touch node electrodes 408, each touch node electrode identifying or representing a unique location on the touch screen at which touch or proximity (i.e., a touch or proximity event) is to be sensed, and each touch node electrode being electrically isolated from the other touch node electrodes in the touch screen/panel, as previously described. Touch node electrodes 408 can be on the same or different material layers on touch screen 402. In some examples, touch screen 402 can sense the self-capacitance of touch node electrodes 408 to detect touch and/or proximity activity on touch screen 402, and in some examples, touch screen 402 can sense the mutual capacitance between touch node electrodes 408 to detect touch and/or proximity activity on touch screen 402.

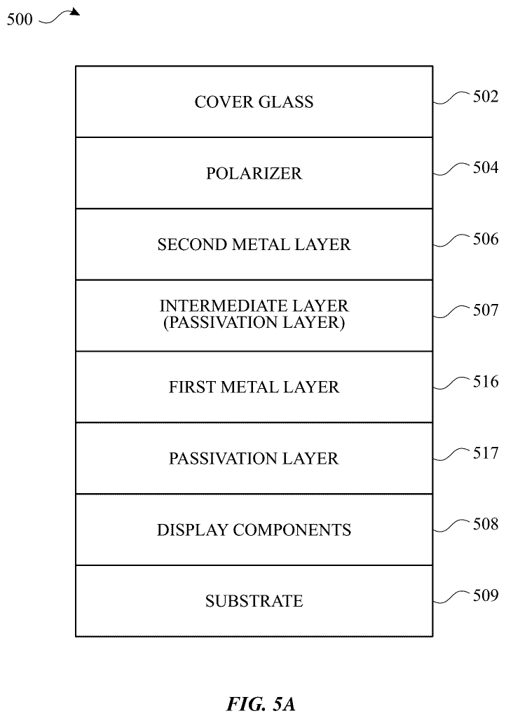

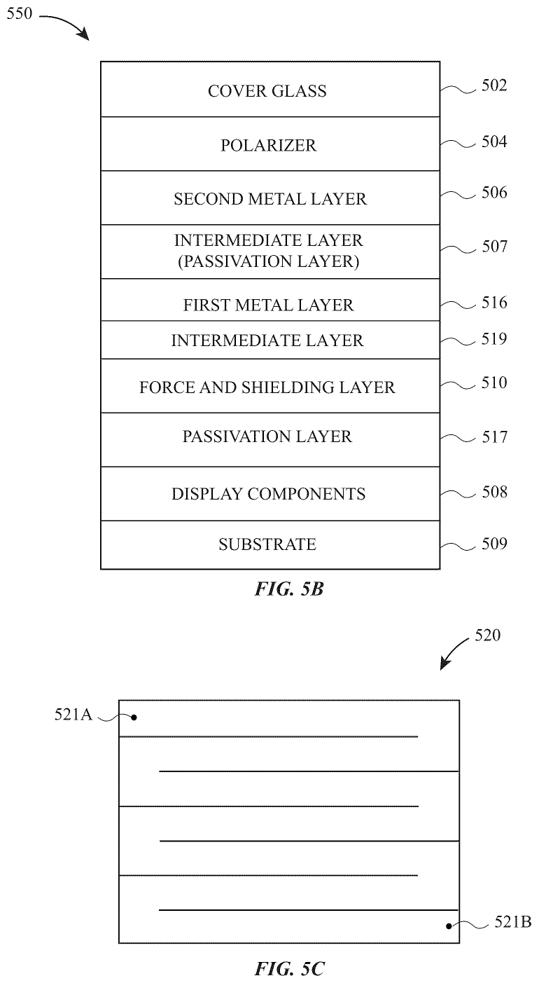

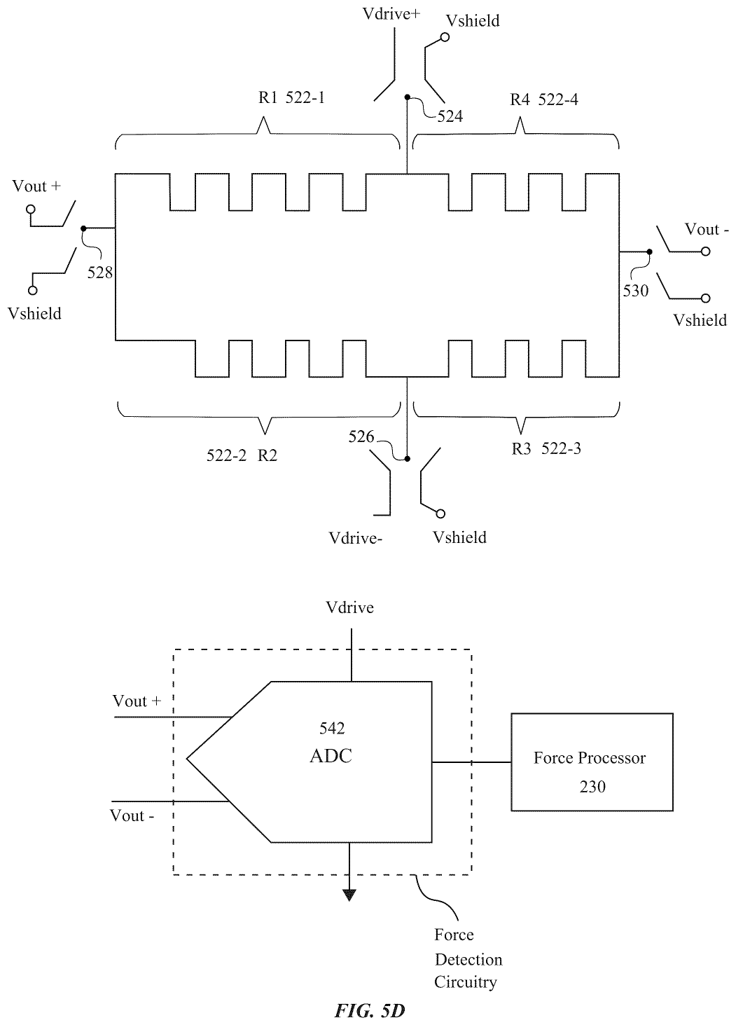

In some examples, some or all of the touch electrodes of a touch screen can be formed from a metal mesh in one or more layers. FIG. 5A illustrates an example touch screen stack-up including a metal mesh layer according to examples of the disclosure. Touch screen 500 can include a substrate 509 (e.g., a printed circuit board) upon which display components 508 (e.g., LEDs or other light emitting components and circuitry) can be mounted. In some examples, the display components 508 can be partially or fully embedded in substrate 509 (e.g., the components can be placed in depressions in the substrate). Substrate 509 can include routing traces in one or more layers to route the display components (e.g., LEDs) to display driving circuitry (e.g., display driver 234). The stack-up of touch screen 500 can also include one or more passivation layers deposited over the display components 508. For example, the stack-up of touch screen 500 illustrated in FIG. 5A can include an intermediate layer/passivation layer 507 (e.g., transparent epoxy), between first metal layer 516 and second metal mesh layer 506, and passivation layer 517. Passivation layers 507 and 517 can planarize the surface for respective metal mesh layers. Additionally, the passivation layers can provide electrical isolation (e.g., between metal mesh layers and between the LEDs and a metal mesh layer). Metal mesh layer 516 (e.g., copper, silver, etc.) can be deposited on the planarized surface of the passivation layer 517 over the display components 508, and metal mesh layer 506 (e.g., copper, silver, etc.) can be deposited on the planarized surface of passivation layer 507. In some examples, the passivation layer 517 can include material to encapsulate the display components to protect them from corrosion or other environmental exposure. Metal mesh layer 506 and/or metal mesh layer 516 can include a pattern of conductor material in a mesh pattern. In some examples, metal mesh layer 506 and metal mesh layer 516 can be coupled by one or more vias (e.g., through intermediate layer/passivation layer 507. Additionally, although not shown in FIG. 5A, a border region around the display active area can include metallization (or other conductive material) that may or may not be a metal mesh pattern. In some examples, metal mesh is formed of a non-transparent material, but the metal mesh wires are sufficiently thin and sparse to appear transparent to the human eye. The touch electrodes (and some routing) as described herein can be formed in the metal mesh layer(s) from portions of the metal mesh. In some examples, polarizer 504 can be disposed above the metal mesh layer 506 (optionally with another planarization layer disposed over the metal mesh layer 506). Cover glass (or front crystal) 502 can be disposed over polarizer 504 and form the outer surface of touch screen 500. It is understood that although two metal mesh layers (and two corresponding planarization layers) are illustrated, in some examples more or fewer metal mesh layers (and corresponding planarization layers) can be implemented. Additionally, it is understood that in some examples, display components 508, substrate 509 and/or passivation layer 517 can be replaced by a thin-film transistor (TFT) LCD display (or other types of displays), in some examples. Additionally, it is understood that polarizer 504 can include one or more transparent layers including a polarizer, adhesive layers (e.g., optically clear adhesive) and protective layers.

In some examples, a touch screen stack-up includes one or more layers of materials configured to shield (e.g., to mitigate noise coupling) between display circuitry and touch detection circuitry during a first mode of operation, and configured to sense force during a second mode of operation. Integrating electrodes for shielding and/or force sensing in one or more on-cell layers reduces thickness of the touch screen stack-up, as compared to alternative devices including shielding and/or force sensing circuitry to separately implement similar shielding and force detecting capabilities. Thus, integrating electrodes for shielding and/or force sensing in one or more on-cell layers reduces the touch screen thickness, consolidates multiple manufacturing processes, reduces manufacturing complexity to fabricate touch screens with these functionalities, and/or reduce potential failure modes when fabricating and/or while using such touch screens.

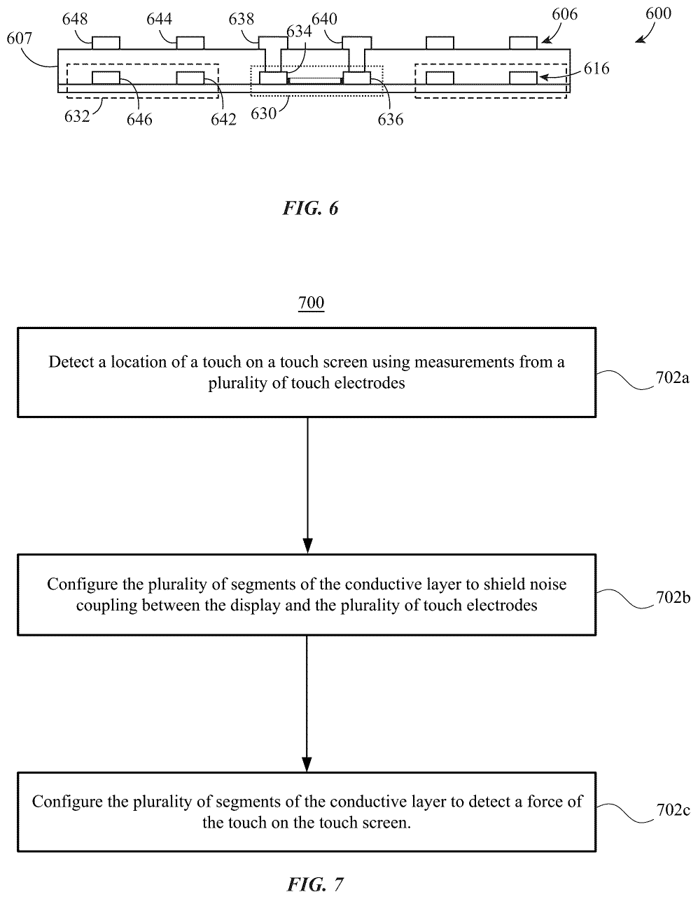

FIG. 5B illustrates an example touch screen stack-up including a dual-function material layer configured to operate as a shield and/or as force sensing circuitry during different modes of operation. In some examples, touch screen 550 illustrated in FIG. 5B has one or more characteristics of touch screen 500 illustrated in FIG. 5A. Further description of similar components between FIGS. 5A and 5B (e.g., cover glass 502, polarizer 504, second metal mesh layer 506, intermediate layer 507, first metal layer 516, passivation layer 517, display components 508, and/or substrate 509) are omitted for brevity. In FIG. 5B, a force and shielding layer 510 is separated from a first metal layer 516 via an intermediate layer 519 having one or more characteristics similar or the same as those of the intermediate layer 507. Force and shielding layer 510 in FIG. 5B can include one or more conductive materials, such as one or more silver nanowires. In some examples, force and shielding layer 510 can be disposed between the display components 508 and metal layers of the touch screen 550, such as metal layer 506 and metal layer 516, configured to detect forces of contacts with touch screen 550 and further configured to prevent noise coupling between the display components 508 and touch electrodes implemented in one or more of the metal layers during different modes of operation of touch screen 550. Configuring force and shielding layer 510 to shield and/or detect force of contacts with touch screen 550 reduces cost, device thickness, and overall manufacturing complexity of touch screen 550 otherwise required to manufacture and adhere separate shield circuitry and/or separate force sensing circuitry to the touch screen 500. Although FIG. 5B illustrates a force and shield layer 510 configured for force and/or shielding operation in different modes, it is understood that force and shield layer 510 could be split into two layers, one providing shielding functionality and one providing force sensing functionality. Additionally although force functionality is shown integrated into force and shield layer 510 in FIG. 5B, it is understood that force sensing functionality is optionally integrated into first metal layer 516 (as shown in FIG. 6), and shielding functionality (without force sensing functionality) can be implemented in a layer currently represented by force and shield layer 510.

For example, as described further with reference to FIG. 5C-5D, during a first mode of operation (e.g., corresponding to capacitive touch sensing), the electrodes of force and shielding layer 510 are connected to a shield voltage. The shield voltage optionally corresponds to an electrical ground (e.g., of the touch screen 550), and/or another voltage configured to attenuate any signals undesirably coupling from display components 508 to the touch electrodes in the metal layers of the touch screen, and/or vice-versa. In some examples, during a second, different mode of operation (e.g., corresponding to force sensing and/or idling of the capacitive touch sensing), the electrodes of force and shielding layer 510 configured as strain gauges. When configured as strain gauges, portions of the electrodes are coupled to one or more stimulation sources, described further with reference to FIGS. 5C-5D, such as one or more voltage sources and/or grounds. As described further with reference to FIGS. 5C-5D, touch screen 550 is optionally configured to detect changes in resistance of one or more electrodes corresponding to one or more strain gauges during the second mode of operation, thus enabling detection of a force of a touch applied to touch screen 550. For example, in response to deformation of the force and shield layer 510 caused by a force of an object pressed against touch screen 550, touch screen 550 detects a change in a voltage measured between two points of an electrode or of multiple electrodes corresponding to a strain gauge in the force and shield layer 510 caused by a change in resistance of the force and shield layer 510. The change in voltage can indicate a magnitude and/or location of force of an object causing the deformation of the touch screen 550 and/or of the force and shield layer 510.

In some examples, force and shielding layer 510 is patterned to enable and/or optimize both the shielding capabilities and/or the force sensing capabilities. For example, shield layer 510 can include a plurality of electrodes (e.g., including silver nanowires or other conductors) arranged in one or more serpentine patterns, such as serpentine pattern 520 illustrated in FIG. 5C. The serpentine pattern 520 can include one or more connection terminals such as node 521A at or near one end of serpentine pattern 520 and node 521B at or near the opposite end of serpentine pattern 520. Such serpentine patterns are optionally configured to provide a linear or near-linear relationship between a magnitude of force applied to force and shielding layer 510 and a change in resistance of an electrode of the plurality of electrodes (e.g., between nodes 521A and 521B). In some examples, characteristics of the serpentine pattern, such a distance along one or more dimensions of an electrode configured in a serpentine pattern, are configured to provide linearity between a change in resistance and a magnitude of force applied to the electrode (e.g., a width, a height, a length, of one or more segments of the serpentine patterns and/or the electrode as a whole). Additionally or alternatively, the characteristics of the serpentine pattern are configured to improve shielding between the display and touch circuitry noise. For example, electrodes(s) arranged in a serpentine pattern(s) such as serpentine pattern 520 illustrated in FIG. 5C included in force and shield layer 510 are optionally configured to shield the touch electrodes from display noise during the first mode of operation. Designing the characteristics of the serpentine patterns can enable such electrodes to as effectively, or nearly as effectively, shield the touch electrodes as a shield layer including a single continuous shield lacking any gaps. For example, the serpentine pattern configured as a shield attenuates unwanted signals coupling between the touch electrodes and the display circuitry 0, 0.001, 0.005, 0.01, 0.05, 0.1, 0.5, and/or 1 dB of a continuous shield having a similar shape and size as the serpentine pattern. In some examples, a thickness of electrodes in the force and shielding layer 510 (e.g., a dimension of the electrodes along an axis extending normal and through the layers of a device corresponding to touch screen 550), the type of conductive material, and/or the density of conductive material (e.g., silver nanowire density) are configured to provide visibility of light emitted by display components 508 and impedance (e.g., resistance) of one or more electrodes having serpentine pattern 520.

In some examples, respective patterns of electrodes in the force and shielding layer 510 are configured independently of respective patterns of touch electrodes in metal layers, such as second metal mesh layer 506 and/or first metal layer 516. For example, the touch electrodes in the metal layers are optionally pixelated or row-column electrodes (e.g., corresponding to the layouts in FIGS. 4A-4B), span particular dimensions of the touch screen, and/or otherwise arranged to accommodate visibility of the images displayed on the screen using display components 508. Because force and shield layer 510 optionally includes transparent, or effectively transparent materials such as the silver nanowires (e.g., with a density low enough to enable optical transmission), the electrodes of force and shield layer 510 optionally are configured with a pattern that does not correspond to patterns of the touch electrodes in the metal layers. The electrodes of the force and shield layer 510, for example, can be un-pixelated, whereas the touch electrodes can be pixelated (e.g., as in FIG. 4B). As another example, the electrodes of the force and shield layer 510 can be arranged where respective legs of serpentine patterns are at a non-parallel angle relative to row-column patterns of touch electrodes (e.g., for a touch electrode in a row-column arrangement as shown in FIG. 4A, a respective first dimension of a respective leg of a serpentine patterned electrode can be non-parallel with the row-axis and/or the column axis and/or a respective second dimension of the respective leg of the serpentine patterned electrode can also be non-parallel with the row-axis and/or the column axis). It is understood that the arrangements and configurations of force and shield layer 510 described herein are exemplary, and non-limiting in any way. For example, force and shield layer 510 optionally includes one or more portions of shielding and/or force sensing circuitry, such as one or more electrodes, arranged with different or the same patterns, dimensions, orientations, and/or are comprised of a same or different densities of silver nanowires.

As described herein, in some examples, the strain gauges are implemented using a Wheatstone bridge architecture. FIG. 5D illustrates a schematic diagram of a Wheatstone bridge according to examples of the disclosure. As described previously, touch screen 550 described with reference to FIG. 5B optionally includes a force and shielding layer 510, which optionally include one or more strain gauges. In some examples, touch screen 550 includes force sensing circuitry (e.g., force sensing circuitry 236 of FIG. 2) couplable to the one or more strain gauges and configured to stimulate and measure the one or more strain gauges. For example, resistor R1 522-1, resistor R2 522-2, resistor R3 522-3, and resistor R4 522-4 optionally correspond to respective electrodes with serpentine patterns (e.g., each corresponding to the electrode with serpentine pattern 520 in FIG. 5C having a resistance between nodes 521A and 521B) included in touch screen 550. In some examples, resistor R1 522-1, resistor R2 522-2, resistor R3 522-3, and resistor R4 522-4 are configured to have a same, or nearly same resistance value (e.g., by tuning the characteristics of the electrodes, such as the pattern, dimensions, and/or material resistance per unit area). In some examples, resistor R1 522-1, resistor R2 522-2, resistor R3 522-3, and resistor R4 522-4 are configured in an unbalanced arrangement, wherein at least two respective resistors have different resistances than one another.

In some examples, the resistors are connected to respective nodes for stimulation and/or shielding operations, described further herein. For example, R1 522-1 is coupled between node 524 and node 528, R2 522-2 is coupled between node 528 and node 526, R3 522-3 is coupled between node 526 and node 530, and R4 522-4 is coupled between node 524 and node 530. Nodes 524 and 526 can be configured to be driven with a drive voltage in the Wheatstone bridge architecture. For example, the drive voltage can be applied (e.g., differentially) as V_{drive+} and V_{drive-} to nodes 524 and 526, or the drive voltage can be applied (e.g., single-endedly) as V_{drive} to node 524 and node 526 can be grounded. Nodes 528 and 530 are optionally configured to be sensed (e.g., differentially or in a single-ended manner) to measure an output voltage between Vₒᵤₜ₊ and Vₒᵤₜ₋. Some or all of nodes 524, 526, 528, and 530 can be driven with a shield voltage (e.g., from shield source 240).

During a first mode of operation, touch screen 550 is optionally configured to shield between touch and display circuitry, and couples node 524, node 528, node 526, and node 530 of the Wheatstone bridge to a similar or same voltage and/or stimulation source by closing the switches between the respective nodes and V_{shield}. The switches and voltage V_{shield} shown in FIG. 5D can correspond to force switching circuitry 242 and shield source 240, respectively, as illustrated in FIG. 2. In some examples, nodes 524, 528, 526, and 530 optionally are coupled to an electrical ground of touch screen 550 during the first mode of operation. In some examples, nodes 524, 528, 526, and 530 are coupled to a non-ground stimulation source instead of the electrical ground configured to actively shield between the touch and display circuitry. During the first mode of operation, touch screen 550 also decouples one or more of nodes 524, 526, 528, and 530 from the stimulation source (e.g., stimulation source 238) represented by V_{drive}+ and V_{drive-}, and/or force detection circuitry (e.g., corresponding to AFE 244) represented by Vₒᵤₜ₊ and Vₒᵤₜ₋.

During a second mode of operation, touch screen 550 is optionally configured to detect force of an object contacting touch screen 550. For example, node 524 is coupled to a drive voltage V_{drive+} via the switches shown (e.g., corresponding to force switching circuitry 236), and decoupled from the shield voltage. Node 526 is coupled to V_{drive-} or a ground node via the switches shown (e.g., corresponding to force switching circuitry 236), and decoupled from the shield voltage. The stimulation voltage applied between nodes 524 and 526 during the second mode of operation allow currents to flow from node 524 to node 526, thus creating a series of voltages across resistor R1 522-1, resistor R2 522-2, resistor R3 522-3, and resistor R4 522-4. Nodes 528 and 530 are coupled to Vₒᵤₜ₊ and Vₒᵤₜ₋, respectively, and decoupled from the shield voltage. Vₒᵤₜ₊ and Vₒᵤₜ₋ are coupled to or configured to be coupled to inputs of ADC 542 (e.g., corresponding to force detection circuitry and/or AFE 244) during the second mode of operation. In the second mode of operation, ADC 542 optionally detects a change in voltage of resistor R1 522-1, resistor R2 522-2, resistor R3 522-3, and resistor R4 522-4, corresponding to the change in resistance of the Wheatstone bridge. ADC 542 is configured to, in the second mode of operation, convert a differential measurement (a difference between Vₒᵤₜ₊ and Vₒᵤₜ₋) and/or other measurements to digital information, which can be obtained by the force processor 230. In response to obtaining the voltage information, force processor 230 is optionally configured to determine an amount of force. In some examples, the force processor 230 correlates the change in voltages to a corresponding change in resistance of the Wheatstone bridge, and optionally correlates the change in resistance to a curve (e.g., a nearly linear curve) between resistance and an amount of applied force. The amount of force is optionally stored in memory of touch screen 550 and/or memory of a device in communication with touch screen 550, such as a mobile or wearable device including the touch screen 550. Accordingly, touch screen 550 optionally determines and/or assists in determining a magnitude of force contacting the touch screen 550 in the second mode of operation.

In some examples, touch screen 550 is configured in the first mode of operation while touch screen 550 concurrently drives display components 508 to display an image to a user of touch screen 550. In some examples, touch screen 550 is configured in the second mode of operation while touch screen 550 is not driving display components 508 to display an image. In some examples, touch screen 550 is configured in the second mode of operation while touch screen is driving display components 508, such as while a location of an object contacting the touch screen 550 determined using touch nodes is not being determined. In some examples, touch screen 550 is configured in the second mode of operation concurrently while the location of the object determined using the touch nodes is being determined.

In some examples, the force sensing circuitry mentioned previously includes a force controller, similar to the touch controller 206, configured for driving, sensing, and/or configuring circuitry for force detection operations. For example, force controller optionally includes RAM, stimulation circuitry, one or more force sensing channels, and/or programs and/or logic to drive and/or sense the Wheatstone bridge. In some examples, the force controller is coupled to the Wheatstone bridge and/or host processor 228. In some examples, the force processor 230 and/or host processor 228 determine a location of the force. For example, the force processor 230 and/or host processor 228 optionally determine a force at a respective Wheatstone bridge corresponding to a first region of touch screen 550 that is deformed by a first magnitude of force, and that determine a force at other Wheatstone bridges included in touch screen 500 at one or more regions of touch screen 550 are deformed by relatively the same and/or lesser magnitudes of force. Accordingly, the force processor 230 and/or host processor 228 optionally determine that the user is optionally deforming touch screen 550 at the first region, and/or one or more regions adjacent to the first region, and supplement the localization of a touch location (e.g., that is initially detected using the touch nodes described with reference to FIG. 2), and/or otherwise supplemented.

As described herein, in some examples, noise from the display can couple to touch electrodes due at least in part to the proximity of the display to the touch electrodes of a touch sensor panel. In some examples, a shield layer or display-noise sensor can be disposed on a printed layer (e.g., an encapsulation layer) to reduce the noise from the display. For example, turning back to FIG. 5B, an example stack-up corresponding to touch screen 550 is illustrated according to examples of the disclosure. In some examples, various layers of touch screen 550 can be formed using a shared manufacturing process. In such examples, components are manufactured and disposed onto their respective locations within touch screen 550 in a serial fashion (e.g., without relying on discrete components that are manufactured at a prior time, and then transferred to a location within touch screen 550). In some examples, components that are both manufactured and disposed onto their respective locations within touch screen 550, and not manufactured separately as discrete, or semi-discrete components, can be referred to as on-chip fabricated/manufactured components, or components fabricated using on-chip technologies for manufacturing. As discussed below, touch screen 550 includes multiple such components that are fabricated using on-chip technologies for manufacturing, which offer several advantages over alternative “discrete” components that require being transferred to touch screen 550.

Touch screen 550 can be built or fabricated upon substrate 509, in some examples. Substrate 509 can be a printed circuit board substrate, a silicon substrate, or any other suitable base substrate material(s) for touch screen 550. Display components 508 can be formed over substrate 509, in some examples, and can include a plurality of display elements arranged in an array (e.g., in rows and columns). Each display element can comprise a display pixel, in some examples. A display pixel can correspond to light-emitting components capable of generating colored light, in some examples. Examples of display pixels can include a backlit Liquid-Crystal Display (LCD), or a Light-Emitting Diode (LED) display, including Organic LED (OLED), Active-Matrix Organic LED (AMOLED), and Passive-Matrix Organic LED (PMOLED) displays. In some examples, a display pixel can include a number of sub-pixels (e.g., one, two, three, or more sub-pixels). As an example, a display pixel can include a red sub-pixel, a green sub-pixel, and a blue sub-pixel, where the various sub-pixels have respective dimensions relative to each other, and relative to the dimensions of the entire display pixel. In some examples, red, green, and blue sub-pixels can have approximately, or substantially similar dimensions to one another (e.g., the sub-pixels are all within a 5% range of a target dimension or area for the sub-pixels). In other examples, a blue sub-pixel can occupy approximately 50% of the area of a display pixel, with red and green sub-pixels occupying the remaining 50% of the area (e.g., each occupying 25% of the display pixel area). In some examples, display components 508 are formed over the entirety of substrate 509. In other examples, display components 508 are formed over portions of substrate 509 (e.g., some portions of substrate 509 do not have display components 508 formed over them).

In some examples, touch screen 550 includes providing a force and shielding layer 510 in this way can sometimes be referred to herein as “manufacture by on-cell process,” or an in situ manufacturing technique. The process of manufacturing display-noise shield/sensor using an on-cell process provides numerous advantages over alternative techniques, where a discrete, or semi-discrete component manufactured using a different process (e.g., at a different time, location, using different manufacturing equipment, etc.) from the process used to manufacture the prior layers (e.g., substrate 509, display components 508, passivation layer 517, and the first encapsulation layer). In some examples, these advantages include the elimination of alignment and lamination steps associated with aligning the (semi-)discrete component associated with a display-noise shield/sensor to the already-manufactured layers and using a laminate or adhesive to affix the component associated with the display-noise shield/sensor to the already-manufactured layers. These advantages of manufacturing display-noise shield/sensor using an on-cell process contribute to lower yield losses of the overall touch screen 550, relative to alternative processes. Additionally or alternatively, in some examples, the thickness of the touch sensor panel can be reduced using the on-cell process compared with a discrete touch sensor laminated to the display, thereby reducing the overall thickness of the touch screen.

In some examples, force and shield layer 510 is disposed on top of an encapsulation layer. The encapsulation layer can sometimes be selectively ink-jet printed onto portions of passivation layer 517 under which display components 508 are formed, in some examples. In such examples, force and shielding layer 510 is formed only on those selectively ink-jet printed portions of the encapsulation layer. In some examples, where force and shielding layer 510 is a shield, the shield can include a single conductive layer (e.g., ITO layer, metal layer) or metal mesh layer. In some examples, the shield layer can be flooded with conductive material(s) (e.g., ITO, metal). In some examples, the shield layer can include with a global mesh pattern such that the footprint of the force and shielding layer 510 can be occupied by an electrically connected conductive metal mesh. In some examples, the shield layer can include a combination of the metal mesh flooded with a conductive material. The conductive materials can help mitigate noise signals generated by display components 508 from interfering with components formed above force and shielding layer 510 in touch screen 550. In some examples, a shield layer including a metal mesh in combination with a flood of conductive material can provide improved isolation compared with metal mesh alone and reduced resistivity compared with a flood of conductive material alone. In such examples, patches of the flood of conductive material can be disposed between the metal mesh, resulting in the layer associated with force and shielding layer 510 sometimes referred to as a layer with alternating metal mesh and conductive material portions (e.g., where the conductive material portions are formed or positioned between gaps in the metal mesh). In such examples, this combination can be formed by first forming a metal mesh layer (e.g., by depositing and/or patterning a first conductive material according to a mesh pattern), and then forming a flood of conductive material between the mesh pattern of the metal mesh layer (e.g., by depositing and/or patterning a second conductive material according to a patch pattern, aligned to the mesh pattern, where paths of material of the mesh pattern are aligned with open paths of the patch pattern). One alternative process to forming the combination can be first forming a flood of conductive material in patches (e.g., by depositing and/or patterning a second conductive material according to a patch pattern), and then forming a metal mesh pattern in spaces between the patches (e.g., by depositing and/or patterning a first conductive material according to a mesh pattern, aligned to the patch pattern, where patches of material of the patch pattern are aligned with open sections of the mesh pattern). Another alternative process to forming the combination can be forming the flood of conductive material as a solid layer first (e.g., directly over the encapsulation layer), and then subsequently forming a metal mesh pattern over the solid layer of the conductive material.

When the shield layer is formed using two conductive materials in this way (e.g., a first material for the mesh pattern, and a second material for the patch pattern), a first conductive material for the mesh pattern can be different from a second conductive material for the patch pattern. As an example, the first conductive material for the mesh pattern can be aluminum (Al), copper (Cu), or any other suitable conductive material for forming a metal mesh in force and shielding layer 510. As another example, the material for the mesh pattern can be a combination of conductive materials deposited as multiple layers, such as a layer of titanium (Ti), onto which a layer of aluminum (Al) is deposited, onto which a layer of titanium (Ti) is deposited). In some such examples, the mesh pattern formed of layers of titanium, aluminum, and titanium can be above the second conductive material, or below the second conductive material. As an example, the second conductive material for the optional patch pattern can be ITO, silver (Ag) nanowire, or any other suitable transparent (or effectively transparent) conductive material for forming patches that can be formed above, below, or between the metal mesh in force and shielding layer 510. Accordingly, in some examples, the layer associated with force and shielding layer 510 can be referred to as a metal mesh layer with patches of ITO, silver, or any other suitable conductive material for forming patches.

In some examples, instead of a contiguous conductive layer (or metal mesh pattern, or a combination of the two) spanning an entirety of the footprint of force and shielding layer 510, a number of conductive segments can be electrically coupled (e.g., using the same metal or a different metal) to form the shield layer. In such examples, the segments can be aligned to sub-pixel elements of display components 508. It is understood, however, that the segments can be configured differently and unaligned with the sub-pixel elements of display components 508, such as when force and shield layer 510 include transparent or nearly transparent materials.

In some examples force and shielding layer 510 can include multiple metal layers or metal mesh layers. Conductive segments with some correspondence to row and column touch electrodes can be formed in one of the metal (mesh) layers of force and shielding layer 510 to form a sensor (e.g., electrodes of the sensor). In some examples, a contiguous column electrode can be formed in a first metal (mesh) layer of force and shielding layer 510, with non-contiguous row electrodes also formed in the first metal (mesh) layer. A second metal (mesh) layer can include bridges that connect the non-contiguous row electrodes in the first metal (mesh) layer, in some examples. In some examples, conductive segments within the metal (mesh) layers of force and shielding layer 510 can have a one-to-one correspondence to row and column touch electrodes of a touch sensor (e.g., each conductive patch of force and shielding layer 510 has a single corresponding touch electrode of touch sensor such that the patterning of the electrodes of the display-noise sensor and the touch electrodes of the touch sensor are the same). In some examples, conductive segments within the metal (mesh) layers of force and shielding layer 510 can have a size based on respective sizes of row and column touch electrodes of touch sensor (e.g., each conductive patch of force and shielding layer 510 has the same or a proportional size to a corresponding touch electrode of the touch sensor). In examples where conductive segments within the metal (mesh) layers of force and shielding layer 510 are smaller than corresponding row and column touch electrodes of the touch sensor, conductive segments within layers of the touch sensor can be centered about a center-point of a corresponding touch electrode of touch sensor. In some examples, conductive segments within the metal (mesh) layers of force and shielding layer 510 are aligned to sub-pixel elements of display components 508 and/or touch electrode of the touch sensor.

In some examples, a second encapsulation layer can be formed over force and shielding layer 510. In some such examples, the second encapsulation layer can be in direct contact with a layer of force and shielding layer 510. Similar to the first encapsulation layer, the second encapsulation layer can be printed using selective printing, or blanket printing. The second encapsulation layer can be referred to as a “printed layer,” when it is deposited over/onto force and shielding layer 510 using a printing or deposition technique, in some examples. The second encapsulation layer can be deposited over/onto force and shielding layer 510 using an ink-jet printing technique, in some examples. Ink-jet printing techniques can cause layers to be selectively deposited (e.g., deposited over a portion of an underlying layer), or globally/blanket deposited (e.g., deposited over an entirety of the underlying layer), in some examples. In some examples, the second encapsulation layer can be ink-jet printed selectively over regions of force and shielding layer 510 under which display components 508 are formed. In other examples, the second encapsulation layer can be ink-jet printed over the entirety of force and shielding layer 510 (e.g., a blanket deposition). In some examples, the second encapsulation layer can be an optically transmissive or transparent layer, through which light emitted from display components 508 can pass. In some examples, a thickness of the second encapsulation layer is less than a threshold thickness (e.g., 10 microns or less, 12 microns or less, 14 microns or less, etc.).

In some examples, touch screen 550 includes a cover layer that can be formed over an adhesive layer, and can include a glass or crystal layer. In some examples, a thickness of the cover layer can be between 60 and 120 microns, or between 75 and 105 microns in other examples. In some examples a thickness of the cover layer is less than a threshold thickness (e.g., 75 microns or less, 95 microns or less, 115 microns or less, etc.).

In some examples, the on-cell manufactured force and shielding layer 510 can be formed by first forming a metal layer over the first encapsulation layer, followed by forming a second encapsulation layer over the metal layer. In examples where the metal layer is flooded or provided with a global metal mesh, a high parasitic capacitance can develop between row/column electrodes of a touch sensor included in touch screen 550 and force and shielding layer 510. In such examples, this high capacitance, can result in results in low bandwidth for touch signal sensing by the touch sensor. An optional dielectric layer can be provided above the second encapsulation layer to isolate the touch sensor from parasitic capacitances with the metal layer. In some examples, a thickness of the metal layer can be between 0.4 and 1 micron, or between 0.5 and 0.9 microns in other examples. In some examples, a thickness of a metal layer can be less than a threshold thickness (0.4 microns or less, 0.6 microns or less, 0.8 microns or less, etc.).

In some examples, the metal layer can be filled with a combination of a flood of conductive material and a metal mesh to provide improved insulation (e.g., compared with mesh alone) and reduced resistivity (compared to a flood of conductive material alone). In some such examples, patches of the flood of conductive material can be disposed between the metal mesh. Sometimes the metal layer can be referred to as having alternating metal mesh and conductive material portions (e.g., where the conductive material portions are formed or positioned between gaps in the metal mesh). In some such examples, the combination can be formed by first forming a metal mesh layer (e.g., by depositing and/or patterning a first conductive material according to a mesh pattern) and then forming a flood of conductive material between the mesh pattern of the metal mesh layer (e.g., by depositing and/or patterning a second conductive material according to a patch pattern, aligned to the mesh pattern, where paths of material of the mesh pattern are aligned with open paths of the patch pattern). Alternatively, the order of material formation can be reversed (e.g., as described above in connection with force and shielding layer 510). One alternative process to forming the combination can be first forming a flood of conductive material in patches, and then forming a metal mesh pattern in spaces between the patches. Another alternative process to forming the combination can be forming the flood of conductive material as a solid layer first, and then subsequently forming a metal mesh pattern over the solid layer of the conductive material.

In some examples, the touch screen 550 includes a dielectric layer, which can sometimes be called an “isolation dielectric layer” or even a “thick dielectric layer,” in reference to its function of separating the touch sensor from force and shielding layer 510 and from display components 508 (e.g., components formed below the touch sensor). In some examples, the dielectric layer can be called “thick” because of its thickness being relatively larger than the thickness of other dielectric layers (such as those of force and shielding layer 510) in touch screen 550 of FIG. 5B. In some examples, a thickness of the dielectric layer can be between 1 and 6 microns, or can be between 2 and 5 microns in other examples. In some examples, a thickness of the dielectric layer can be less than a threshold thickness (e.g., 2 microns or less, 5 microns or less, 8 microns or less). Separating the touch sensor from components formed below it (e.g., by the inclusion of the dielectric layer) reduces the impact of noise and/or interference from said components, and additionally reduces the parasitic capacitances between the touch sensor and said components, in some examples.

FIG. 6 illustrates a cross-sectional view of an example shield and force detecting device according to examples of the disclosure. For example, touch screen 600 optionally is a device manufactured with a material layer that is configured in first one or more regions as an interconnect between touch sensing circuitry, and in one or more second regions as a force sensing circuitry. For example, touch screen 600 includes a first metal layer 616—corresponding to the first metal layer 516 of FIG. 5A—and a second metal layer 606—corresponding to the second metal layer 506 of FIG. 5A. It is understood that dependent upon context, first metal layer 616 and second metal layer 606 have one or more characteristics described with reference to corresponding metal layers described with reference to FIGS. 5A-5B. For example, first metal layer 616 and second metal layer 606 are optionally comprised of similar or the same materials as metal layers described with reference to FIGS. 5A-5B.

In some examples, first metal layer 616 includes electrodes configured to detect a force of an object contacting touch screen 600. In some examples, first metal layer 616 is fabricated with electrodes including a strain-sensitive material, such as copper-nickel, such that the electrodes of the first metal layer 616 are able to be driven and/or sensed to detect a magnitude of applied force and/or strain, similar or the same as described with reference to the force and shield sensing layer 510 with reference to FIG. 5B. For example, a first region 632 of the first metal layer 616 optionally includes a first strain gauge 646 and a second strain gauge 642 (portions of which are shown in the cross-sectional view of FIG. 6) comprising a force-sensitive material. In some examples, the first metal layer 616 also is configured to couple a plurality of touch sensing electrodes. For example, second region 630 of touch screen 600 optionally includes a first jumper 634 and a second jumper 636, coupling together touch electrode 638 and touch electrode 640 (described further herein). In some examples, the first and the second regions of the first metal layer 616 are comprised of the same materials, and are disposed simultaneously (or nearly simultaneously), and/or are disposed during a same step and/or series of steps of the manufacturing process. For example, the first metal layer 616 is disposed and/or etched, and overlaid over passivation layer 517 described with reference to FIG. 5A and before intermediate layer 507 is disposed. Touch screen 600 further includes second metal layer 606, which can be fabricated including a different material (e.g., a different metal material, including titanium, copper, and/or another material described herein with reference to touch metal layers). The device illustrated in FIG. 6 offers numerous advantages, including reducing an overall manufacturing complexity otherwise required to laminate separate layers for electrical interconnects and force sensing circuitry.

In some examples, strain gauge 646 and strain gauge 642 have one or more characteristics of the resistors and/or strain gauges described with reference to FIG. 5D. For example, strain gauge 646 and strain gauge 642 are optionally representative of a plurality of strain gauges included in touch screen 550, optionally include and/or correspond to one or more Wheatstone bridges included in touch screen 550, and/or are optionally configured to detect a force of an object contacting the touch screen 550. In some examples, strain gauge 646 and strain gauge 642 are disposed at positions below corresponding touch-sensitive electrodes (relative to the cross-sectional view of touch screen 600 presented in FIG. 6), such as touch electrode 648 and touch electrode 644 that correspond to touch electrodes and/or sensors included in touch screen 600, such that touch screen 600 is able to obtain information indicative of a force of an object contacting touch screen 600 at a same, or nearly same, location of a detected touch.

In the second region 630 of touch screen 600, the same first metal layer 616 is optionally configured to couple together segments of touch electrodes formed of the second metal layer 606. For example, touch electrode 638 and touch electrode 640 optionally are touch node electrodes formed in second metal layer 606, and disposed above the second region 630 (relative to the cross-sectional view of touch screen 600 presented in FIG. 6). To extend the effective dimensions of the electrodes and simplify connections between touch electrodes and stimulation circuitry (e.g., stimulation sources exciting the touch electrodes), second region 630 of the first metal layer 616 can be configured as electrical interconnects, coupling adjacent touch electrodes 638 and 640, while minimizing the footprint of the touch electrodes. For example, in FIG. 6, touch screen 600 includes a plurality of vias such that electrodes 638 and 640 extend vertically relative to the cross-sectional view of touch screen 600, electrically and mechanically connecting to jumper 634 and jumper 636, respectively. Jumper 634 and jumper 636 can be coupled to one another (not show in FIG. 6), offering a minimal or near-zero Ohm resistance (e.g., less than a threshold such as 5 Ohms, 10 Ohms, 100 Ohms, etc.), to extend a capacitive sensing profile of touch electrode 638 and 640. In some examples, first jumper 634 and second jumper 636 are coupled to one another via a portion of metal material (e.g., formed in first metal layer 616), thus electrically connecting electrode 638 and electrode 640.

In some examples, the portion of first metal layer 616 configured as force-sensing circuitry is relatively greater than the portion of first metal layer 616 configured as electrical interconnects. In some examples, a pitch between adjacent legs of a serpentine-shaped strain gauge formed in first metal layer 616 is configured to minimize and/or avoid overlapping with underlying display components and/or circuitry (e.g., to avoid blocking light from display LEDs). In some examples, touch screen 600 can be incorporated into the touch screens described with reference to FIGS. 5A-5B, such as in addition or alternative to the metal layers 506 and 516 and intermediate layer 507. In some examples, touch screen 600 can be included in touch screen 550 in place of the force and shielding layer 510. It is understood that first region 632 and second region 630 can be replicated across the dimensions of touch screen 600 to offer a plurality of strain sensing and interconnect regions of first metal layer 616. It is further understood that the number and arrangement of regions corresponding to first region 632 and/or second region 630 can differ from the examples described herein.

In some examples, the strain gauges described herein are arranged to encompass the dimensions of underlying display circuitry, such that a touch screen including the strain gauges is able to detect a location and/or magnitude of force of an object contacting the touch screen across the entirety of the touch screen. In some examples, the touch screen is configured to detect a location of the touch (e.g., using touch electrodes), and in response to detecting the location of touch, configures one or more nearby strain gauges to detect a force of the touch, and forgoes configuring one or more strain gauges not corresponding to the location of touch for force detection. For example, the strain gauges are individually addressable (similar to the touch electrodes described herein) such that the touch screen can excite individual strain gauges corresponding to the location of touch to conserve power consumption required to stimulate and/or sense the strain gauges. Accordingly, the strain gauges optionally are optionally arranged in a grid (e.g., in rows and columns), and optionally with a relatively fine size (e.g., 10 mm across in an X and Y direction of the strain gauges). In some examples, the force detection and the stimulus of strain gauges are used to determine an initial localization of the object contacting a touch screen, and based on the initial localization, touch electrodes (e.g., rows and/or columns of touch electrodes) corresponding to the initial location indicated by the force information are driven and sensed to determine a finer resolution touch location, while touch electrodes not corresponding to the initial location are not driven and/or sensed. In some examples, the strain gauges are configured to detect a plurality of simultaneous contacts, and are configured to sense magnitudes of the respective contacts on a touch screen.

FIG. 7 illustrates an example method for configuring a touch screen stack-up to detect force according to examples of the disclosure. In some examples, a method 700 is performed at a touch and force sensitive touch screen comprising a display, a plurality of touch electrodes, and a conductive layer patterned into a plurality of segments and disposed between the display and the plurality of touch electrodes. In some examples, the touch and force sensitive touch screen and/or processing circuitry communicatively coupled to the touch and force sensitive touch screen detects (702a) a location of a touch on the touch screen using measurements from the plurality of touch electrodes. In some examples, in a first period, the touch and force sensitive touch screen and/or processing circuitry configures (702b) the plurality of segments of the conductive layer to shield noise coupling between the display and the plurality of touch electrodes. In some examples, in a second period, different from the first period, the touch and force sensitive touch screen and/or processing circuitry communicatively coupled to the touch and force sensitive touch screen configures (702c) the plurality of segments of the conductive layer to detect a force of the touch on the touch screen.

Therefore, according to the above, some examples of the disclosure are directed to a touch and force sensitive touch screen. In some examples, the touch and force sensitive touch screen comprises a display. In some examples, the touch and force sensitive touch screen comprises a plurality of touch electrodes. In some examples, the touch and force sensitive touch screen comprises a conductive layer disposed between the display and the plurality of touch electrodes, and the conductive layer can be patterned into a plurality of segments. In some examples, in a first period the plurality of segments can be configured to shield the plurality of touch electrodes from the display, and in some examples, in a second period the plurality of segments can be configured as one or more strain gauges. In some examples, the processing circuitry can be configured to couple to the plurality of touch electrodes and the plurality of segments, and to detect a location of a touch on the touch screen using measurements of the plurality of touch electrodes and detect a force of the touch on the touch screen using measurements of the plurality of segments.

Additionally or alternatively to one or more of the examples disclosed above, in some examples, the first segment of the plurality of segments of the conductive layer includes one or more silver nanowires.

Additionally or alternatively to one or more of the examples disclosed above, in some examples, a first segment of the plurality of segments has a serpentine pattern.

Additionally or alternatively to one or more of the examples disclosed above, in some examples, the touch and force sensitive touch screen can comprise switching circuitry coupled to the plurality of segments of the conductive layer and to sensing circuitry. In some examples, the processing circuitry further configured to, in the first period, couple the plurality of segments of the conductive layer to the sensing circuitry via the switching circuitry to determine the force of the touch on the touch screen, and in the second period, different from the first period, couple the plurality of segments of the conductive layer via the switching circuitry to an electrical potential of the touch and force sensitive touch screen.

Additionally or alternatively to one or more of the examples disclosed above, in some examples, the force sensing circuitry is couplable to the plurality of segments, and the processing circuitry can configure (702c) the force of the touch on the touch screen using measurements of the plurality of segments from the sensing circuitry.

Additionally or alternatively to one or more of the examples disclosed above, in some examples, the force sensing circuitry can be configured to sense one or more Wheatstone bridge circuits, the one or more Wheatstone bridge circuits including a first Wheatstone bridge circuit including a first plurality of resistors corresponding to a subset of the plurality of segments of the conductive layer.

Additionally or alternatively to one or more of the examples disclosed above, in some examples, the force sensing circuitry includes one or more sense lines couplable to respective resistors of a plurality of resistors included in the first Wheatstone bridge circuit.

Additionally or alternatively to one or more of the examples disclosed above, in some examples, the plurality of touch electrodes includes a first plurality of electrodes in a first metal layer and a second plurality of electrodes in a second metal layer, and the touch and force sensitive touch screen further comprises a dielectric layer.

Additionally or alternatively to one or more of the examples disclosed above, in some examples, the touch and force sensitive touch screen comprises a plurality of metal bridges formed in the second metal layer, configured to couple one or more pairs of electrodes of the first plurality of electrodes.

Additionally or alternatively to one or more of the examples disclosed above, in some examples, the touch and force sensitive touch screen comprises a plurality of strain gauges formed in the second metal layer configured to detect the force of the touch on the touch and force sensitive touch screen at a plurality of locations.

Additionally or alternatively to one or more of the examples disclosed above, in some examples, the touch and force sensitive touch screen the plurality of touch electrodes can be patterned in a first pattern, and the plurality of segments of the conductive layer can be patterned in a second pattern, different from the first pattern.

Additionally or alternatively to one or more of the examples disclosed above, in some examples, the first pattern corresponds to a mesh pattern, and the second pattern corresponds to a serpentine pattern.

Additionally or alternatively to one or more of the examples disclosed above, in some examples, a first portion of the plurality of segments of the conductive layer can be configured with a first pattern, and second portion, different from the first portion, of the plurality of segments of the conductive layer can be configured with a second pattern, different from the first pattern.

Some examples of the disclosure are directed to a touch and force sensitive touch screen a method performed at a touch and force sensitive touch screen comprising a display, a plurality of touch electrodes, and a conductive layer patterned into a plurality of segments and disposed between the display and the plurality of touch electrodes. In some examples, the method comprises detecting a location of a touch on the touch screen using measurements from the plurality of touch electrodes. In some examples, the method comprises in a first period, configuring the plurality of segments of the conductive layer to shield noise coupling between the display and the plurality of touch electrodes. In some examples, the method comprises in a second period, different from the first period, configuring the plurality of segments of the conductive layer to detect a force of the touch on the touch screen.

Additionally or alternatively to one or more of the examples disclosed above, in some examples a first segment of the plurality of segments of the conductive layer includes one or more silver nanowires.

Additionally or alternatively to one or more of the examples disclosed above, in some examples a first segment of the plurality of segments has a serpentine pattern.

Additionally or alternatively to one or more of the examples disclosed above, in some examples the touch screen further comprises switching circuitry coupled to the plurality of segments of the conductive layer and to sensing circuitry. In some examples, the method comprises in the first period, coupling the plurality of segments of the conductive layer to the sensing circuitry via the switching circuitry to determine the force of the touch on the touch screen. In some examples, the method comprises in the second period, different from the first period, coupling the plurality of segments of the conductive layer via the switching circuitry to an electrical potential of the touch and force sensitive touch screen.

Some examples of the disclosure are directed to memory storing instructions configured to be executed by a processor in communication with a touch and force sensitive touch screen comprising a display, a plurality of touch electrodes, and a conductive layer patterned into a plurality of segments disposed between the display and the plurality of touch electrodes. In some examples, the instructions when executed by the processor cause the touch and force sensitive touch screen to detect a location of a touch on the touch screen using measurements from the plurality of touch electrodes. In some examples, the instructions when executed by the processor cause the touch and force sensitive touch screen to in a first period, configure the plurality of segments of the conductive layer to shield noise coupling between the display and the plurality of touch electrodes, and in a second period, different from the first period, configure the plurality of segments of the conductive layer to detect a force of the touch on the touch screen.

Additionally or alternatively to one or more of the examples disclosed above, in some examples a first segment of the plurality of segments of the conductive layer includes one or more silver nanowires.

Additionally or alternatively to one or more of the examples disclosed above, in some examples a first segment of the plurality of segments has a serpentine pattern.

1. A touch and force sensitive touch screen device comprising:
a display;
a plurality of touch electrodes;
a conductive layer disposed between the display and the plurality of touch electrodes, wherein the conductive layer is patterned into a plurality of segments, wherein in a first period the plurality of segments is configured to shield the plurality of touch electrodes from the display, and wherein in a second period the plurality of segments is configured as one or more strain gauges; and
processing circuitry coupled to the plurality of touch electrodes and the plurality of segments, the processing circuitry configured to detect a location of a touch on the touch screen using measurements of the plurality of touch electrodes and detect a force of the touch on the touch screen using measurements of the plurality of segments.

2. The touch and force sensitive touch screen device of claim 1, wherein a first segment of the plurality of segments of the conductive layer includes one or more silver nanowires.

3. The touch and force sensitive touch screen device of claim 1, wherein a first segment of the plurality of segments has a serpentine pattern.

4. The touch and force sensitive touch screen device of claim 1, further comprising:
switching circuitry coupled to the plurality of segments of the conductive layer and to sensing circuitry, the processing circuitry further configured to:
in the first period, couple the plurality of segments of the conductive layer to the sensing circuitry via the switching circuitry to determine the force of the touch on the touch screen; and
in the second period, different from the first period, couple the plurality of segments of the conductive layer via the switching circuitry to an electrical potential of the touch and force sensitive touch screen.

5. The touch and force sensitive touch screen device of claim 1, further comprising force sensing circuitry couplable to the plurality of segments, wherein the processing circuitry is further configured to, in the first period, determine the force of the touch on the touch screen using measurements of the plurality of segments from the sensing circuitry.

6. The touch and force sensitive touch screen of claim 5, wherein the force sensing circuitry is configured to sense one or more Wheatstone bridge circuits, the one or more Wheatstone bridge circuits including a first Wheatstone bridge circuit including a first plurality of resistors corresponding to a subset of the plurality of segments of the conductive layer.

7. The touch and force sensitive touch screen of claim 6, wherein the force sensing circuitry includes one or more sense lines couplable to respective resistors of a plurality of resistors included in the first Wheatstone bridge circuit.

8. The touch and force sensitive touch screen of claim 1, wherein the plurality of touch electrodes includes a first plurality of electrodes in a first metal layer and a second plurality of electrodes in a second metal layer, and the touch and force sensitive touch screen further comprises a dielectric layer.

9. The touch and force sensitive touch screen of claim 8, further comprising:
a plurality of metal bridges formed in the second metal layer, configured to couple one or more pairs of electrodes of the first plurality of electrodes.

10. The touch and force sensitive touch screen of claim 8, further comprising a plurality of strain gauges formed in the second metal layer configured to detect the force of the touch on the touch and force sensitive touch screen at a plurality of locations.

11. The touch and force sensitive touch screen of claim 1, wherein the plurality of touch electrodes is patterned in a first pattern, and the plurality of segments of the conductive layer is patterned in a second pattern, different from the first pattern.

12. The touch and force sensitive touch screen of claim 11, wherein the first pattern corresponds to a mesh pattern, and the second pattern corresponds to a serpentine pattern.

13. The touch and force sensitive touch screen of claim 1, wherein a first portion of the plurality of segments of the conductive layer is configured with a first pattern, and second portion, different from the first portion, of the plurality of segments of the conductive layer is configured with a second pattern, different from the first pattern.

14. A method comprising:
at a touch and force sensitive touch screen comprising a display, a plurality of touch electrodes, and a conductive layer patterned into a plurality of segments and disposed between the display and the plurality of touch electrodes:
detecting a location of a touch on the touch screen using measurements from the plurality of touch electrodes;
in a first period, configuring the plurality of segments of the conductive layer to shield noise coupling between the display and the plurality of touch electrodes; and
in a second period, different from the first period, configuring the plurality of segments of the conductive layer to detect a force of the touch on the touch screen.

15. The method of claim 14, wherein a first segment of the plurality of segments of the conductive layer includes one or more silver nanowires.

16. The method of claim 14, wherein a first segment of the plurality of segments has a serpentine pattern.

17. The method of claim 14, wherein the touch screen further comprises switching circuitry coupled to the plurality of segments of the conductive layer and to sensing circuitry, the method further comprising:
in the first period, coupling the plurality of segments of the conductive layer to the sensing circuitry via the switching circuitry to determine the force of the touch on the touch screen; and
in the second period, different from the first period, coupling the plurality of segments of the conductive layer via the switching circuitry to an electrical potential of the touch and force sensitive touch screen.

18. A non-transitory computer readable medium comprising:
memory storing instructions, wherein the instructions are configured to be executed by a processor in communication with a touch and force sensitive touch screen comprising a display, a plurality of touch electrodes, and a conductive layer patterned into a plurality of segments disposed between the display and the plurality of touch electrodes, and wherein the instructions when executed by the processor cause the touch and force sensitive touch screen to:
detect a location of a touch on the touch screen using measurements from the plurality of touch electrodes;
in a first period, configure the plurality of segments of the conductive layer to shield noise coupling between the display and the plurality of touch electrodes; and
in a second period, different from the first period, configure the plurality of segments of the conductive layer to detect a force of the touch on the touch screen.

19. The non-transitory computer readable medium comprising of claim 18, wherein a first segment of the plurality of segments of the conductive layer includes one or more silver nanowires.

20. The non-transitory computer readable medium comprising of claim 18, wherein a first segment of the plurality of segments has a serpentine pattern.
